(19) United States
(12) Patent Application Publication
(10) Pub. No.: US 2015/0371158 A1
(43) Pub. Date: Dec. 24, 2015

(54) ENHANCED DISPOSITION MONITORING WITH GEOCODING

(71) Applicants: Joseph S. Oberweis, Sugar Grove, IL (US); Akash Takyar, New Delhi (IN); Shaifali Garg, New Delhi (IN)

(72) Inventors: Joseph S. Oberweis, Sugar Grove, IL (US); Akash Takyar, New Delhi (IN); Shaifali Garg, New Delhi (IN)

(73) Assignee: OBERWEIS DAIRY, INC., North Aurora, IL (US)

(21) Appl. No.: 13/083,139

(22) Filed: Apr. 8, 2011

(51) Int. Cl. G06Q 10/06; H04W 4/02; G06F 17/30

(52) U.S. Cl. CPC G06Q 10/067; H04W 4/023; G06F 17/30241; G06F 17/30598

(57) ABSTRACT

An enhanced disposition monitoring module may be provided in a plurality of computing devices (e.g., a handheld computing device, a remote server, etc.) to receive, transmit, maintain, and/or analyze disposition and related information that may be associated with geocoded information (e.g., a street address). The enhanced disposition monitoring module may generate a report based on the analysis of the information, including for example, reports showing performance of salespeople and sales in particular neighborhoods. Moreover, the collected information may be analyzed and the resulting data models may be licensed to third-party entities.

### RELATED APPLICATIONS

This application is related to U.S. application Ser. No. ______ (Attorney Docket No. 006085.00072), which was concurrently filed with this application, and which is herein incorporated by reference in its entirety.

### TECHNICAL FIELD

Aspects of the disclosure generally relate to enhanced disposition monitoring with geocoding. In particular, various aspects of the disclosure include methods and systems for receiving, transmitting, maintaining, and/or analyzing disposition and related information associated with geocoded information.

### BACKGROUND

Geocoding refers to the process of finding the correct geographic coordinates (e.g., latitude and/or longitude coordinates) from data such as street addresses, zip codes, postal codes, etc. Over the years, various geocoding techniques involving address interpolation, the use of land parcel centroids, and the use of global positioning systems (GPS) have been developed. However, problems remain with using these systems/methods for practical geocoding applications. For instance, a geocoding system may fail when several different addresses may be listed under similar names and/or when a given address encompasses an area beyond a threshold value.

In addition, handheld systems are known in the package delivery industry for tracking the status/progress of delivery of a mailed package. In such systems, a delivery truck driver may use a wireless handheld device to manually enter information about the delivery of a package. For example, when a package is delivered, the recipient of the package may sign his/her name onto the handheld device to confirm receipt. The delivery confirmation may be upload in realtime to a remote server where the time and date of the delivery may be displayed to users. Such systems, however, are deficient in numerous aspects.

Furthermore, systems are known for tracking the whereabouts of delivery and sales people. The location of such people may be displayed on a map in realtime. Such maps may generate and display the position of a particular GPS coordinate where a sales person may be located and use known mapping technologies to generate the display. However, such systems are deficient in numerous aspects.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, computer readable media, and apparatuses for maintaining a comprehensive data store (e.g., database) of sales dispositions (e.g., no answer; answered, but did not allow conversation; no solicitation sign on premises; answered, heard pitch, but not interested; reason stated by customer for declining service: too expensive, bad impression of brand, want organic, lactose intolerant or allergic; other; follow-up at particular date/time (and whether left sample); person will call if interested; started service with promotion code; other) provided by sales people using mobile, handheld devices. In addition, the handheld device may provide the salesperson with information (e.g., whether the household is a current/former customer, the date/time of last contact with the customer and disposition, other notes/comments entered about the household, etc.) about a particular household before (or as) the salesperson is approaching the house.

The handheld system may include one or more modules, including but not limited to an enhanced disposition monitoring module and/or an enhanced geocoding module. The modules may be implemented as hardware/software modules either in a mobile device and/or a fixed-location computing device. The enhanced disposition monitoring module may assist in performing one or more of the steps mentioned previously mentioned above.

The enhanced geocoding module may assist in locating physical addresses close to the salesperson on a single street. The enhanced geocoding module may be used to locate physical addresses close to a predetermined location (e.g., close to an entity on a single street, lane, road, alley, or some other thoroughfare). In either scenario, a user of the device may specify a location (e.g., latitude/longitude coordinates, street address, etc.) that the enhanced geocoding module may use as a base location or address in returning other addresses or locations situated on a single street and close to the base location or address. Alternatively, a location tracking system (e.g., global positioning system (GPS), etc.) embedded within the device, in some embodiments, may first determine the current location of a user and use the current location to return other addresses or locations situated on a single street and close to the current location or address.

In some embodiments, the handheld device may query a remote server to obtain and cache disposition information about the other street addresses returned. As such, the responsiveness of the handheld system may be improved.

In addition, aspects of the disclosure may be provided in a computer-readable medium having computer-executable instructions to perform one or more of the process steps described herein.

This summary is provided to introduce a selection of concepts in a simplified form that are further described below in the detailed description. The summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and is not limited in the accompanying figures in which like reference numerals indicate similar elements and in which:

FIG. 1 shows an illustrative operating environment in which various aspects of the disclosure may be implemented.

FIG. 2 is an illustrative block diagram of workstations and servers that may be used to implement the processes and functions of one or more aspects of the present disclosure.

FIG. 3 shows a sample display screen associated with enhanced disposition monitoring module in accordance with one or more aspects of the disclosure.

FIG. 4 shows another sample display screen associated with enhanced disposition monitoring module in accordance with one or more aspects of the disclosure.

FIG. 5 shows illustrative steps of a method in accordance with one or more aspects of the disclosure.

FIG. 6 shows another sample display screen associated with enhanced disposition monitoring module in accordance with one or more aspects of the disclosure.

FIG. 7 shows yet another sample display screen associated with enhanced disposition monitoring module in accordance with one or more aspects of the disclosure.

### DETAILED DESCRIPTION

As discussed herein, in various embodiments an enhanced disposition monitoring module may be provided in a plurality of computing devices (e.g., handheld computing device, remote server, etc.) An enhanced disposition monitoring module in a handheld mobile computing device (e.g., smartphone, tablet, laptop, mobile phone, etc.) may receive disposition information and transmit (e.g., wirelessly transmit) that information to a remote server. Also, the handheld mobile computing device may display historical disposition information received from a remote server.

Meanwhile, a corresponding enhanced disposition monitoring module in a remote computing device (e.g., server, etc.) may receive information transmitted from a plurality of handheld mobile computing devices and store that information. Also, the remote computing device may analyze the collected disposition and other information (e.g., geocoded information associated with the disposition information) and generate one or more reports and or rules based on the analysis. For example, reports may be generated showing the performance of sales people (e.g., door-to-door salespeople) operating handheld tablet devices around different neighborhoods. The analyzed information and reports may be used to create a data model to improve sales performance and/or efficiency.

In addition, the collected information and data model resulting from an analysis of that information may be licensed or sold to third-party entities. For example, the analyzed information may assist in identifying the best time of day and/or day of week to attempt an in-person sale at person's home. In another example, a third-party providing complementary services/products may use the database of collected information and data model to identify and target potential sale leads. In yet another example, a third-party providing unrelated services/products (e.g., a political campaign) may use the collected information to identify and target homes for solicitation and/or visitation.

In some examples in accordance with various aspects of the disclosure, the interactive system of handheld computing devices and remote server may also be used to assist salespeople in locating each other and coordinating efforts. For example, each handheld computing device may display a map indicating the location of the other salespeople with their respective handheld computing devices. As such, each salesperson can coordinate neighborhoods and geographical areas of coverage. In another example, the disposition of a home may be displayed on the aforementioned map, but those dispositions that occurred most recently (e.g., in the last day, in the last week, etc.) may be drawn with a larger icon (e.g., a larger circle) to indicate the recency of the in-person visit. As time progresses, the icon may be rendered incrementally smaller to reflect that the last visit occurred in the past accordingly. The handheld computing devices may receive, in some embodiments, a near realtime (e.g., every minute, or some other period of time) update from a remote server to reflect the movement of other salespeople. In another embodiment, the handheld computing device may receive updated position information about other salespeople's coordinates only upon manual request (e.g., when the device uploads information to a remote server) or at regular predetermined intervals (e.g., every ten minutes, every sixty seconds, twice an hour, etc.)

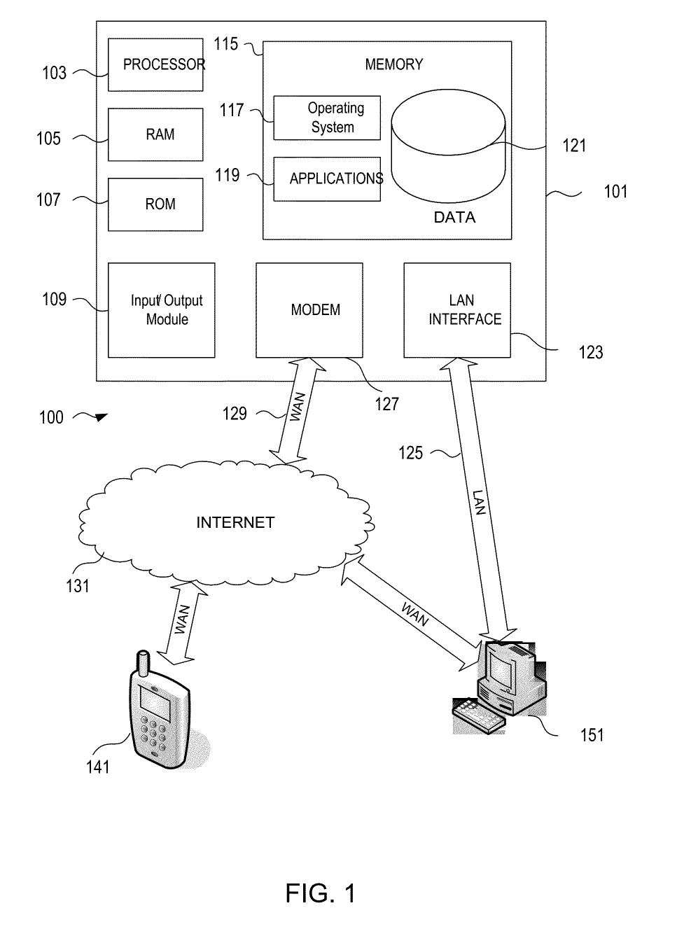

Referring to FIG. 1, that figure illustrates a block diagram of a computing device 101 (e.g., a computer server) in communication system 100 that may be used according to an illustrative embodiment of the disclosure. The device 101 may have a processor 103 for controlling overall operation of the computing device 101 and its associated components, including RAM 105, ROM 107, input/output (I/O) module 109, and memory 115.

I/O 109 may include a microphone, keypad, touch screen, and/or stylus through which a user of the computing device 101 may provide input, and may also include one or more of a speaker for providing audio output and a video display device for providing textual, audiovisual and/or graphical output. Software may be stored within memory 115 and/or storage to provide instructions to processor 103 for enabling computing device 101 to perform various functions. For example, memory 115 may store software used by the device 101, such as an operating system 117, application programs 119, and an associated database 121. Processor 103 and its associated components may allow the device 101 to run a series of computer-readable instructions to generate a rectangular grid for determining the physical addresses that are closest to a given location. For instance, when the geocode of a mobile device is determined, processor 103 may create a grid with the geocode of the mobile device at the center of the grid. In addition, processor 103 may create several coordinate points around the center of the grid so that a reverse geocoding server may be called to reverse the geocodes of the various coordinate points into physical addresses.

The server 101 may operate in a networked environment supporting connections to one or more remote computers, such as mobile computing device 141 and computing device 151. The computing devices 141 and 151 may be personal computers or servers that include many or all of the elements described above relative to the computing device 101. Alternatively, computing devices 141 and/or 151 may be a reverse geocoding server called by computing device 101 to reverse the geocode of various coordinate points on a grid into physical addresses. The network connections depicted in FIG. 1 include a local area network (LAN) 125 and a wide area network (WAN) 129, but may also include other networks. When used in a LAN networking environment, the server 101 is connected to the LAN 125 through a wireless network interface or adapter 123. When used in a WAN networking environment, the server 101 may include a modem 127 or other means (e.g., wireless communications circuitry) for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the computing device 101 according to an illustrative embodiment of the disclosure may include computer executable instructions for invoking functionality related to creating a rectangular grid for locating addresses on a single street.

Computing devices 101, 141, 151 may, in some embodiments, be mobile terminals, such as smart phones, personal digital assistants (PDAs), etc. including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, handheld or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked, for example, through a communications network. In a distributed computing environment, program modules may be located in both local and remote computer storage media including memory storage devices.

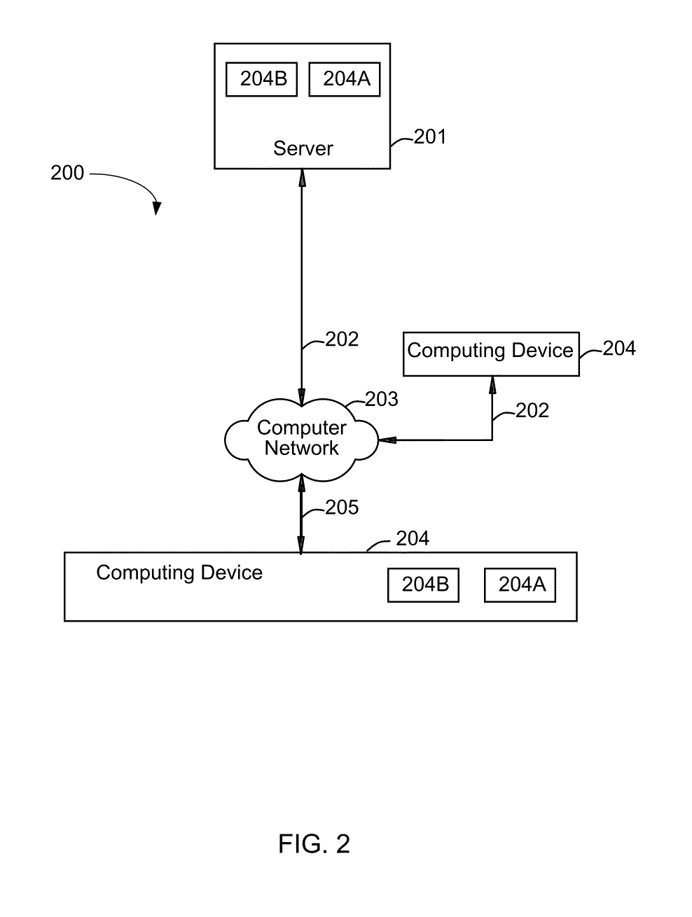

Referring to FIG. 2, an illustrative sales management computer system 200 for implementing methods according to the present disclosure is shown. As illustrated, system 200 may include one or more computing devices 204, 206 and one or more workstation servers 201. Server 201 may be local or remote, and are connected by one or more communications links 202 to computer network 203 that is linked via communications links 205 to the computing device 204. In certain embodiments, workstation server 201 may be different servers that reverse the geocode of coordinate points provided by one or more modules in computing device 204, or, in other embodiments, workstation server 201 may be different computing devices (e.g., mobile devices) mapped by computing device 204. In system 200, the computing devices 204, 206 may be any suitable server, processor, computer, or data processing device, or combination of the same, as illustrated in computing device 101 in FIG. 1.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstation server 201 and server (e.g., computing devices 204, 206), such as network links, dial-up links, wireless links, hard-wired links, etc.

The disclosure that follows in the Figures may be implemented by one or more of the components in FIGS. 1 and 2 and/or other components, including other computing devices.

In accordance with various aspects of the disclosure, methods, computer-readable media, and apparatuses are disclosed in which an enhanced geocoding module 204A configured to operate in computing device 204 may locate addresses located on a single street, lane, alley, gulley, road, or other thoroughfare. To accomplish this task, the geocode of the computing device 204 may be extracted. In some embodiments, the geocode of a predetermined point specified by a user may be extracted using the enhanced geocoding module. The geocode may refer to any of several geospatial attributes, including latitude, longitude, altitude, date, time, and/or internet protocol (IP) address. Then the enhanced geocoding module may create a grid with a predetermined granularity around the extracted geocode. The granularity of a grid may refer to the distance between any two coordinate points of the grid. The extracted geocode of enhanced geocoding module may be located at the center of the grid; then enhanced geocoding module may create several coordinate points around the grid. Next, enhanced geocoding module may make a batch request to a server (e.g., via an application programming interface (API) of a server such as one maintained by Google, Microsoft, etc.) to reverse the geocodes of each of the coordinate points on the grid into physical addresses.

Once a call is made to the reverse geocoding server (e.g., computing devices 141/151 and/or workstations 201) to reverse the geocode of a given coordinate point, this coordinate point and its associated physical address may be saved in a memory of the enhanced geocoding module 204A to avoid having to make repeated calls to the reverse geocoding server for the same physical address.

Enhanced geocoding module 204A may then sort the physical addresses in order of how far they are from the enhanced geocoding module. The physical addresses that are the closest to the enhanced geocoding module may then be presented to a user on a display screen of the enhanced geocoding module. All of the physical addresses located on a single street may be grouped and presented to a user in an order consistent with how far the physical addresses are from the user of the enhanced geocoding module or consistent with how far the physical addresses are from some other user specified location. In this way, the enhanced geocoding module may present physical addresses to a user via a two-tiered sorting technique-first the addresses may be sorted by street and then these same-street addresses may be sorted by distance from the enhanced geocoding module.

In addition, as described in U.S. application Ser. No. ______ (Attorney Docket No. 006085.00072), which was concurrently filed with this application and previously incorporated by reference herein, the enhanced geocoding module 204A may provide additional features and aspects including, but not limited to, icons for overlaying on a map representing addresses, variable-distance grid points to account for varying density of population in areas and other factors, alternate grid-like techniques using radial distance from a particular coordinate, and other features.

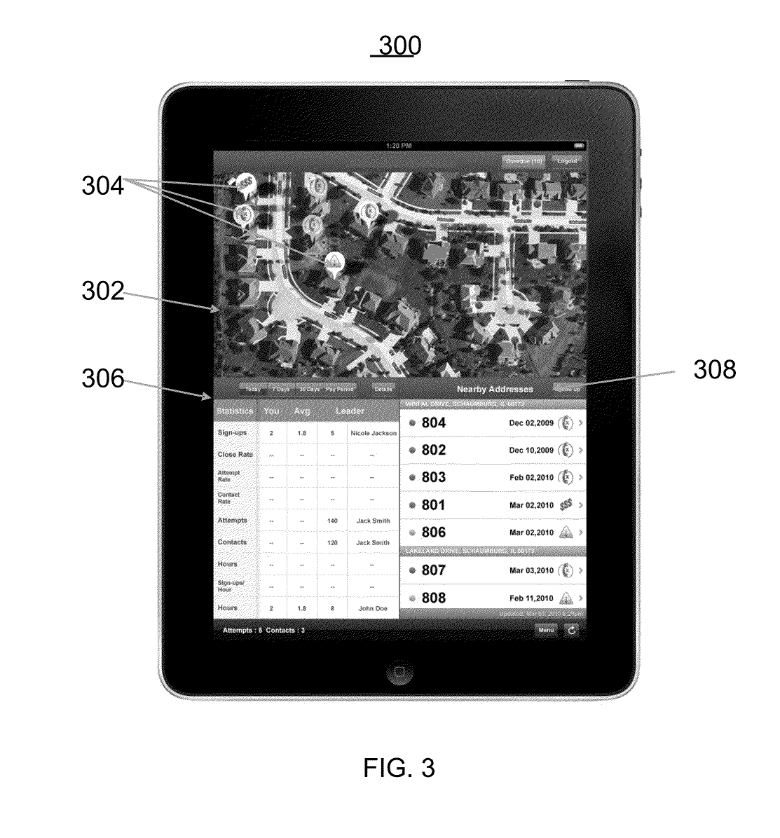

FIG. 3 shows a sample display screen 300 associated with enhanced geocoding module 204A and enhanced disposition monitoring module 204B in accordance with at least one aspect of the disclosure. The display screen associated with the enhanced geocoding module may present a map 302 with various physical addresses located on the same street that are close to the enhanced geocoding module and the icons 304 associated with those addresses. The display screen 300 may also with the enhanced disposition monitoring module 204B present a statistics section 306 on individuals/groups associated with an entity managing the mobile computing device 204. For instance, a company may use the enhanced disposition monitoring module 204B to collect information about and track the performance of its salespersons as they visit various homes within a neighborhood (e.g., for selling and/or delivering milk, insurance, etc.).

The statistics in statistics section 306 may be displayed over various time periods, including a day, week, month, or pay period. Statistics in statistics section 306 may be shown for a given individual/group (e.g., a user of mobile computing device 204), as well as the average value of various statistics for an entire group and the identity of the leader of each statistic. The statistics may include a given salesperson's sign-ups, close rate, attempt rate, contact rate, attempts, contacts, hours, and sign-ups per hour. The salesperson's sign-ups may relate to the number of customers that the salesperson actually convinced to signup for services/products provided by the company, the close rate may represent the number of sign-ups attributed to a given salesperson compared to the total number of potential customers visited, the attempt rate may refer to the total number of potential customers that a given salesperson visits, the contact rate may refer to the total number of potential customers that a given salesperson contacts using any communication modality (e.g., phone, mail, etc.), the attempts may refer to the total number of attempts made by a given salesperson at acquiring new customers, the contacts may refer to the total number of contacts or leads for potential customers as developed by a given salesperson, the hours may refer to the total number of hours that a given salesperson spends mining for potential customers, and the sign-ups per hour may refer to the number of sign-ups attributed to a given salesperson per hour on the job.

The display screen 300 may also display a physical addresses section 308 in which various physical addresses that are shown on the map 302 are shown, sorted by street and distance from the mobile computing device 204. In displaying the physical addresses section 308, the display screen 300 may also use various color codes (e.g., red, yellow, green) to represent the status of potential customers/customers located at the physical address. In one embodiment, red may be used to designate physical addresses that house current customers of a company using enhanced disposition monitoring module 204B, yellow may be used to designate physical addresses that house former customers of the company, and green may be used to designate physical addresses that house potential customers of the company.

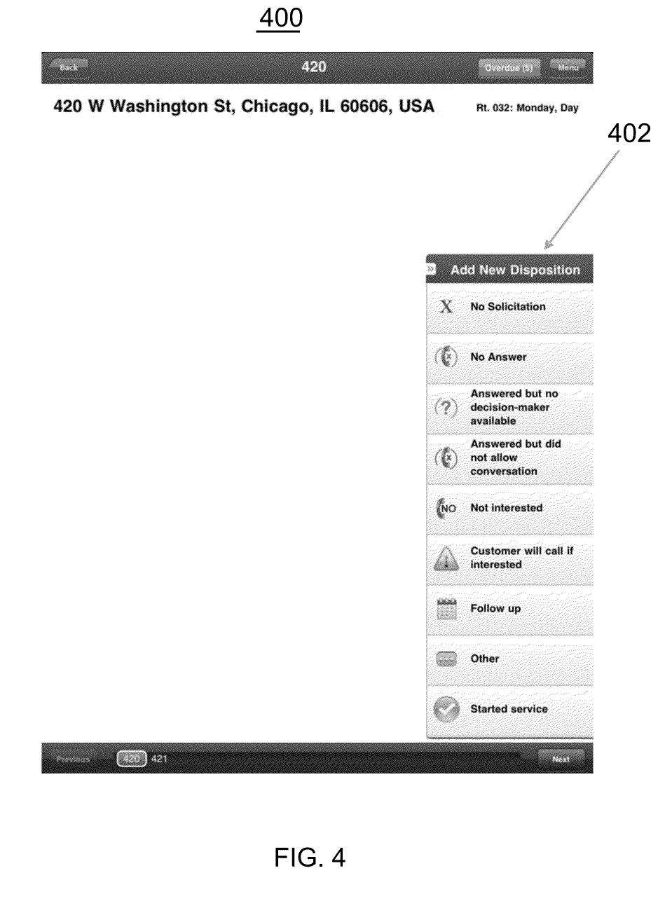

Referring to FIG. 4, that figure illustrates an exemplary screen display 400 of a computing device 141 where a user may select a disposition after visiting a home (e.g., at 420 W. Washington Street). The user may be presented with a list 402 of predetermined dispositions for selection. Some examples of dispositions include “no solicitation,” “no answer,” “not interested,” “started service”, and others. In addition, the user may select “other” if none of the predetermined dispositions apply. The selected disposition may be saved on the computing device 204, and then transmitted to a remote server 201 for storage, maintenance, and analysis. In addition to the disposition information (e.g., “no solicitation”), the geocoded information associated with the disposition (e.g., the address of the home—420 W. Washington St.) and other information (e.g., time of day, date, zip code, state, sales region, identity and/or attribute of sales person operating mobile device (e.g., name, experience level, sales success rating, gender, race, age, and/or other demographics/statistics) and other useful information) may also be saved. The remote server 201 may analyze the disposition information and other information using the enhanced disposition monitoring module 204B. The analysis may, for example, flag a particular address or address block as untouchable (e.g., prohibiting door-to-door sales activity) because of “no solicitation” signs. In such an example, the server 201 (e.g., second enhanced disposition monitoring module 204B) may generate and transmit a message indicating the prohibited status of the area to the mobile computing device 204. When the mobile computing device 204 is within the vicinity of the particular geographic area and determines its geocoded coordinates, the system may display (e.g., on a display of the mobile computing device 204) the message in association with the particular physical addresses that intersect (e.g., fall within either partially or fully) the particular geographic area. In yet another example, the analysis may be used to generate one or more reports evaluating the performance of salespeople.

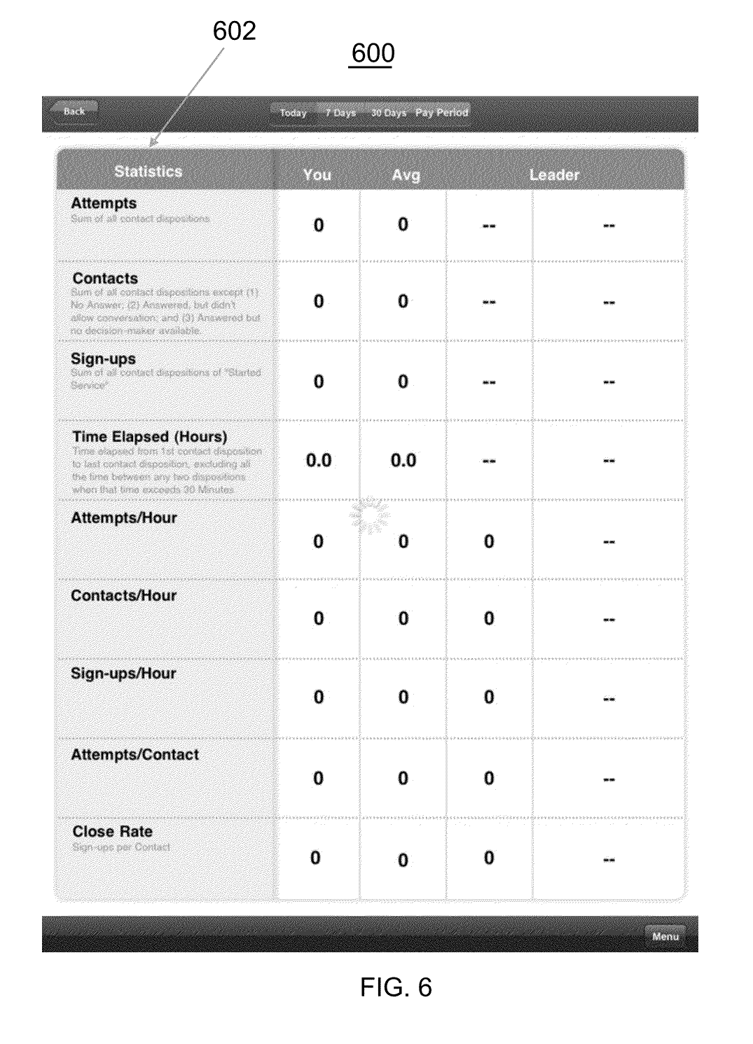

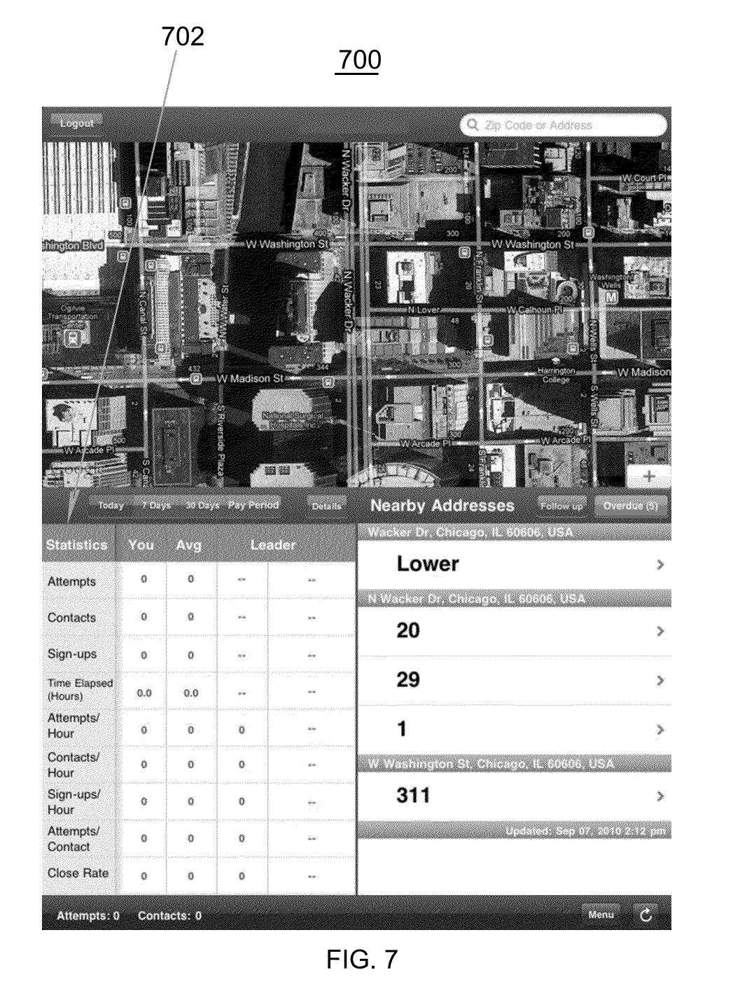

FIG. 6 and FIG. 7 show additional sample display screens 600, 700 associated with an enhanced disposition monitoring module 204B in accordance with one or more aspects of the disclosure. As illustrated in FIG. 4, a list 602 of dispositions is displayed, along with statistics about each disposition. A user may compare his/her performance as compared to the average performance of other users (e.g., salespeople). The handheld computing device displaying screen 600 may query a remote server to obtain other historical data (e.g., data over a 7-day period, 30-day period, or a “pay period”) for display to the user. Similar to FIG. 3, a screen 700 may be displayed showing a map (e.g., satellite image, political map, elevation map, etc.) of a region and dispositions in that region. In addition, a table 702 may be displayed with statics about dispositions and other information as compared to the user, the average of all users, and a leader. The information displayed may be received from server 201 (e.g., enhanced disposition monitoring module 204B) as a generated message or report. One of skill in the art after review of the entirety disclosed herein will appreciate that other desired statistics and information may be displayed (e.g., whether a household is a current customer, former customer, or not a customer; a date of last contact with the household and its resulting sales disposition; and other comments about the household).

In another example in accordance with various aspects of the disclosure, a user (e.g., a salesperson or a door-to-door representative) may activate a software application on their handheld mobile computing device 204 while on a door-to-door sales campaign. The software application, using one or more modules 204A/204B, may communicate the device's coordinates to a remote server 201. The server 201, using one or more modules 204A/204B, may generate a message/report indicating various information about numerous physical addresses (e.g., home addresses, business addresses, etc.) in the vicinity of the user. Upon receipt of the generated messages, the mobile computing device 204 may cache the generated message(s) with their associated physical addresses. As such, when the user approaches a target destination, the mobile computing device 204 may display useful information about the destination (e.g., prior sales dispositions, etc.) on a screen of the mobile computing device 204 before the user reaches the target destination. One skilled in the art will appreciate after review of the entirety disclosed herein that speed of information retrieval may be beneficial to a user (e.g., salesperson) who desires to make the most sales (or solicitations/servicing of any type) in the least amount of time.

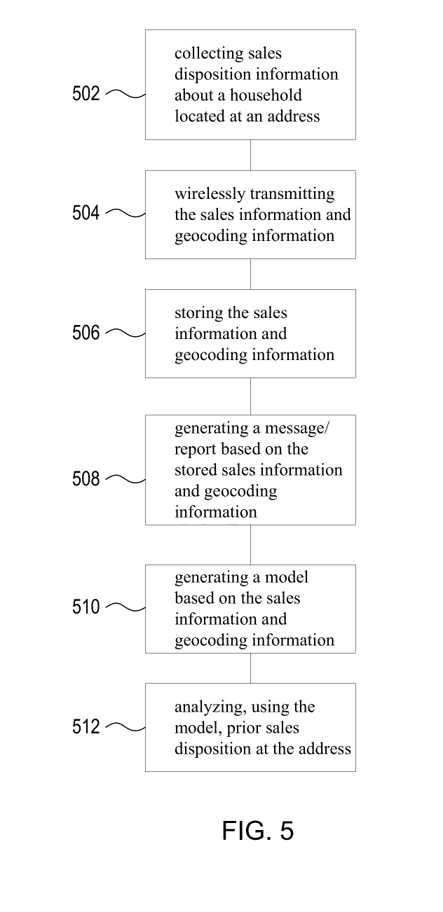

FIG. 5 shows illustrative steps of a method in accordance with one or more aspects of the disclosure. In step 502, sales disposition information may be collected at a handheld computing device. The disposition information may be about a household located a particular address. The address may be calculated using an enhanced geocoding module, as described herein. In step 504, the sales disposition information and geocoding information may be wirelessly transmitted from the handheld device to a remote server. The remote server may store the aforementioned information, in step 506. In step 508, one or more reports may be generated based on the stored sales information and geocoding information at the remote server. Salespeople and/or sales managers may reference the reports in determining sales targets and assignments. Furthermore, in step 501, a model may be generated based on the sales and geocoding information. The model may be used, in step 512, to analyze prior sales disposition information at a particular address. The analysis may be useful in determining the likelihood of success at the particular address given the time of day, day of week, and other variables associated with the in-person sales visit/solicitation.

In other examples in accordance with various aspects of the disclosure, the system 200 may be used for collecting information about and developing a model around door-to-door political campaigning. For example, information about the party affiliations of homes (i.e., physical addresses) may be stored in the system 200 and use to develop a model for identifying those neighborhoods that would benefit most from political door-to-door communications. In addition, the disclosure contemplates that the analysis and model may be used for application in identifying which addresses to provide paper mailing (e.g., brochures, leaflets, etc.) for political and non-political solicitations. In addition, the system 200 may be used in the context of assisting service professionals identify the best times and day of week to visit particular homes. In addition, the disclosure contemplates that the collected data and/or model may be separately licensed and/or used apart from the users/organization collecting the data. As such, the system 200 provides a comprehensive method for collecting pertinent data about household for numerous and a myriad of applications.

Aspects of the disclosure have been described in terms of illustrative embodiments thereof. Numerous other embodiments, modifications and variations within the scope and spirit of the disclosure will occur to persons of ordinary skill in the art from a review of this disclosure.

1. A method comprising:
collecting sales disposition information using a first enhanced disposition monitoring module in a mobile computing device, wherein the sales disposition information comprises an indication of no answer and no solicitation sign on premises;
collecting, by a global positioning system, which comprises an enhanced geocoding module, in the mobile computing device, geocoding information;
transmitting, by the mobile computing device, the sales disposition information and the geocoding information to a remote computing device;
storing the sales disposition information and the geocoding information in a remote data store in communication with the remote computing device;
generating, by a second enhanced disposition monitoring module in the remote computing device, a message comprising sales disposition information collected about one or more addresses in a vicinity of a location corresponding to the geocoding information;
displaying, on a display of the mobile computing device while the mobile computing device is in the vicinity of the location corresponding to the geocoding information, the message;
generating a model based on the collected sales disposition and geocoding information;
analyzing, by the remote computing device, the model to identify rules including a time of day at which an in-person sale attempt is most likely to be successful; and
adjusting the model based on the analysis.

2. The method of claim 1, wherein the sales disposition information includes an indication of one or more of:
no answer;
answered, but did not allow conversation;
no solicitation sign on premises;
answered, heard pitch, but not interested for at least one of the following reasons: too expensive, bad impression of brand, want organic, and lactose intolerant or allergic;
follow-up at particular date/time and whether left sample;
person will call if interested; and
started service with promotion code.

3. The method of claim 1, wherein sales disposition information includes an indication of one or more of:
answered, but did not allow conversation;
no solicitation sign on premises; and
answered, heard pitch, but not interested for at least one of the following reasons: too expensive, bad impression of brand, want organic, lactose intolerant or allergic, and other.

4. The method of claim 1, wherein the message includes an indication of one or more of:
whether a household is a current customer, former customer, or not a customer;
a date of last contact with the household and its resulting sales disposition; and
comments entered about the household.

5. The method of claim 1, wherein the analyzing results in identification of a particular geographic area as prohibiting door-to-door sales activities, the method further comprising:
generating a plurality of coordinate points on a grid that has a center at the location corresponding to the geocoding information;
determining the one or more addresses in the vicinity of the plurality of coordinate points on the grid, wherein the one or more addresses are on a same thoroughfare as the location corresponding to the geocoding information;
displaying a map, on the display of the mobile computing device, comprising the one or more addresses on the same thoroughfare as the location corresponding to the geocoding information.

6. The method of claim 1, wherein the geocoding information is generated using at least an enhanced geocoding module.

7. The method of claim 6, further comprising:
receiving the generated message on the mobile computing device before the mobile computing device reaches a target destination falling within a vicinity of the geocoding information; and
caching the generated message on the mobile computing device.

8. (canceled)

9. The method of claim 1, wherein the transmitting of sales disposition information is performed wirelessly using a wireless transmitter in the mobile computing device.

10. A sales management computer system comprising:
a computer processor;
an enhanced disposition monitoring module; and
a tangible computer memory storing computer-executable instructions, which when executed by the processor, cause the computer system to perform steps comprising:
receiving, from a mobile computing device comprising an enhanced geocoding module, sales disposition information and geocoding information;
storing, using the enhanced disposition monitoring module, the sales disposition information and geocoding information in a data store;
generating, using the enhanced disposition monitoring module, a message comprising information about one or more addresses in a vicinity of a location corresponding to the geocoding information; and
generating, using the enhanced disposition monitoring module, a model based on the collected sales disposition and geocoding information, the model including a time of day at which an in-person sale attempt is most likely to be successful.

11. The system of claim 10, wherein the sales disposition information includes an indication of one or more of:
no answer;
answered, but did not allow conversation;
no solicitation sign on premises;
answered, heard pitch, but not interested for at least one of the following reasons: too expensive, bad impression of brand, want organic, and lactose intolerant or allergic;
follow-up at particular date/time and whether left sample;
person will call if interested; and
started service with promotion code.

12. The system of claim 10, wherein the sales disposition information includes an indication of one or more of:
answered, but did not allow conversation;
no solicitation sign on premises; and
answered, heard pitch, but not interested for at least one of the following reasons: too expensive, bad impression of brand, want organic, lactose intolerant or allergic, and other.

13. The system of claim 10, wherein the memory further stores computer-executable instructions, which when executed by the processor, cause the computing device to perform steps comprising:
analyzing the model to identify rules.

14. The system of claim 13, wherein the analyzing results in identification of a particular geographic area as prohibiting door-to-door sales activities, and wherein the memory further stores computer-executable instructions, which when executed by the processor, cause the computing device to perform steps comprising:
generating, using the enhanced disposition monitoring module, a message indicating the prohibited status of the area when the geocoding information from the mobile computing device is within a vicinity of the particular geographic area.

15. The system of claim 10, further comprising:
an enhanced geocoding module configured to generate at least some of the geocoding information.

16. The system of claim 10, wherein the message includes an indication of one or more of:
whether a household is a current customer, former customer, or not a customer;
a date of last contact with the household and its resulting sales disposition; and
comments entered about the household.

17. A non-transitory computer-readable medium storing computer-executable instructions, which when executed by a computing device, cause the computing device to perform steps comprising:
receiving, through a wireless communications network, sales disposition information and geocoding information, wherein the sales disposition information comprises an indication of no answer and no solicitation sign on premises;
storing, using an enhanced disposition monitoring module, the sales disposition information and geocoding information in a data store;
generating, using the enhanced disposition monitoring module, a message comprising information about one or more addresses in a vicinity of a location corresponding to the geocoding information; and
generating for display on a screen, using the enhanced disposition monitoring module, a map of the one or more addresses in the vicinity of the location corresponding to the geocoding information, wherein a selected address, from the one or more addresses, is identified by an icon having an icon size corresponding to an age of data associated with the selected address.

18. The non-transitory computer-readable medium of claim 17, wherein the sales disposition information includes an indication of one or more of:
answered, but did not allow conversation;
no solicitation sign on premises; and
answered, heard pitch, but not interested for at least one of the following reasons: too expensive, bad impression of brand, want organic, lactose intolerant or allergic, and other.

19. The non-transitory computer-readable medium of claim 17, wherein the message includes an indication of one or more of:
whether a household is a current customer, former customer, or not a customer; and
a date of last contact with the household and its resulting sales disposition.

20. The non-transitory computer-readable medium of claim 17, further storing computer-executable instructions, which when executed by a computing device, cause the computing device to perform steps comprising:
generating, using the enhanced disposition monitoring module, a data model based on the collected sales disposition and geocoding information.

21. The method of claim 1, comprising:
transforming, using the second enhanced disposition monitoring module, the message to indicate a prohibited status of the one or more addresses in the vicinity of the location corresponding to the geocoding information.
